(19) United States
(12) Patent Application Publication
(10) Pub. No.: US 2020/0317086 A1
(43) Pub. Date: Oct. 8, 2020

(54) ENERGY TRANSMISSION IN THE ZERO SYSTEM

(71) Applicant: Dr. Ing. h.c. F. Porsche Aktiengesellschaft, Stuttgart (DE)

(72) Inventors: Stefan Goetz, Forstern (DE); Jan Kacetl, Gemmrigheim (DE); Tomas Kacetl, Gemmrigheim (DE)

(21) Appl. No.: 16/763,369

(22) PCT Filed: Jun. 27, 2018
(86) PCT No.: PCT/EP2018/025178

§ 371 Date: May 12, 2020

(30) Foreign Application Priority Data
Nov. 14, 2017 (DE) 10 2017 126 704.2

(51) Int. Cl. B60L 58/22; B60L 50/60; B60L 58/12; H02P 5/74

(52) U.S. Cl. CPC B60L 58/22; B60L 50/66; B60L 53/20; H02P 5/74; B60L 58/12

(57) ABSTRACT

A method is provided for an energy transmission between at least two energy stores (914, 924) in a respective zero system of at least two n-phase electric machines (912, 922), in which one respective n-phase electric machine (912, 922) has a field winding that is brought together at a star point. The respective field winding is provided with n-windings corresponding to respective n-phases and has a neutral point (902), a respective energy store (914, 924) is assigned, and an electric connection is established in terms of circuitry between windings of corresponding phases, or between the neutral points (902) of the respective field windings of the at least two n-phase electric machines (912, 922) and a respective identical pole of the energy stores (914, 924). Thus, an energy transmission between the at least two energy stores (914, 924) that have a different charge state is carried out.

### BACKGROUND

Field of the Invention. The invention relates to a method and to a system for energy transmission between at least two energy stores by means of respective zero-phase sequence systems of N-phase electric motors.

Related Art. Some electrically operated motor vehicles have electric motors respectively on a front axle and on a rear axle, and these respective electric motors have a separate AC system. The reason for this is different effects on the front and rear axle for example during driving around a corner or in unstable driving situations, for example in the case of drifting or sliding. Furthermore, a sharp acceleration causes a shift in the center of gravity of a motor vehicle in the direction of the rear axle and sharp braking causes a shift in the center of gravity in the direction of the front axle. As a result, a torque that is to be applied or that is applied in the respective electric motor increases and, therefore synonymously based on power flows from an energy store, an increased power inflow to the electric motor of the rear axle or an increased power outflow to an energy store, so-called recuperation, takes place.

Electric motor vehicles usually have a single energy store to supply power to the respective electric motors of the front and rear axle via a respective inverter. Each motor generally is a three-phase motor and an inverter generates a three-phase current for the respective three-phase motor from a direct current provided by the energy store. Power inflows or power outflows of the respective three-phase motors act on the same energy store. Thus, a state of charge of the energy store is dependent only on an overall amount of withdrawn or infed energy.

If an energy store also is present for an electric motor of the front and rear axle, the respective state of charge is dependent on a load arising at the respective axle. An acceleration process mainly leads to a power outflow from an energy store associated with the electric motor for the rear axle, and a braking process mainly leads to a power inflow to an energy store associated with the electric motor for the front axle. Thus, a difference in the states of charge of the respective energy stores, which brings about a need for energy transmission between the energy stores so as not to limit a range of the motor vehicle through different discharging of the energy stores, increases as the driving duration increases. Although methods for energy transmission are known, they have until now been very ineffective.

US 2012/112674 discloses a method for controlling, by means of modulation of a signal, a flow of power to the three-phase motor by means of an inverter that is associated with the three-phase motor and that executes a pulse-width-modulation method. The modulation of a signal can also consist of feeding in a third harmonic.

DE 10 2013 200 674 describes a vehicle that has two on-board power supply subsystems and an inverter assigned to a stator system of a polyphase electric motor. The inverter is assigned to the first on-board power supply subsystem. Currents and therefore energy can be exchanged with the second on-board power supply subsystem via a neutral point, also referred to as a star point, of the stator implemented in a star circuit.

WO 2016/174117 A1 describes an energy store that consists of a plurality of battery modules that can be interconnected among one another to form a star point formation in which three strands consisting of at least one battery module are formed. Accordingly three phases of a three-phase current are formed for the operation of a respective three-phase motor.

Against this background, it is an object of the invention to provide a method for power transmission between two energy stores that is higher compared to the prior art. Each energy stores is associated with a respective electric motor and having a different state of charge. It is also an object of the invention to provide a corresponding system for carrying out such a method.

### SUMMARY

The invention relates to a method for energy transmission between at least two energy stores in a respective zero-phase sequence system of at least two N-phase electric machines, in which a respective energy store is assigned to a respective N-phase electric machine that comprises a field winding joined at a star point. The respective field winding has N windings corresponding to respective N phases and a neutral point, and an electrical connection is established in terms of circuitry between windings of corresponding phases or between the neutral points of the respective field windings of the at least two N-phase electric machines and a respective identical pole of the energy stores. As a result, energy is transmitted between the at least two energy stores that have a different state of charge. With respect to one embodiment, either a positive pole or a negative pole is selected as respective identical pole for all energy stores. In addition to the implementation of the method in a passenger motor vehicle, in which a respective electric machine including an assigned energy store is provided for a front and a rear axle, an implementation for a three-axle truck is also conceivable, in which accordingly three electric machines including respectively assigned energy stores are provided, or for a system, in which a respective electric machine including an assigned energy store is provided for each individual wheel of a motor vehicle.

The N-phase electric machine is understood as an energy converter that is an electric motor or a generator, depending on whether electrical power is converted to mechanical power or vice versa. An N-phase alternating current is required for operation and corresponds, for example, to a three-phase current when N=3 phases. By way of a symmetrical component method known from the prior art, an N-phase AC system can be segmented into N components, which respectively contribute or do not contribute to an applied torque. Those components that do not contribute to the torque, which are also referred to as zero-sequence components by a person skilled in the art, can be combined in what is known as a zero-phase sequence system. In the event of a three-phase current, what is known as a positive phase-sequence system, which moves concomitantly with a rotating field, what is known as a negative phase-sequence system, which runs counter to the rotating field, and the zero-phase sequence system are obtained. The zero-phase sequence system presents a degree of freedom over which energy can be transferred from a first energy store through the field winding of the electric machine without influencing electromechanical energy conversion in the process. To transmit the energy to a second energy store, which itself is assigned to a second electric machine, either windings of corresponding phases or the neutral points of the respective field windings of the two electric machines have to be connected to one another. A flow of energy between the energy stores is then only determined by the potential difference of the energy stores.

In one embodiment of the method, a switch is arranged between windings of corresponding phases or between the neutral points of the respective field windings for the purpose of establishing the electrical connection in terms of circuitry. The exception forms a system having two energy stores, in which only one switch is required. A control unit equipped with a computer processor and a computer program running on the computer processor may control a respective energy store to operate an N-phase electric machine assigned to the energy store and therefore also feeds in the N-th harmonic. Accordingly, the control unit may control the respective switch so that the otherwise closed switch opens at times at which an N-th harmonic is fed in.

In another embodiment of the method, the windings of corresponding phases or the neutral points of the respective field windings are electrically fixedly wired to one another and a respective switch is arranged in the connections between a respective identical pole of the at least two energy stores. The switch may be actuated in the same manner described in the preceding paragraph. In general, the switches can be inserted at any location of a circuit including the connection between the respective field windings without, however, upon opening, stopping the functioning of a system, assigned to the switch, composed of the electric machine and the energy store assigned to the electric machine.

In one embodiment of the method, the circuitry connection is established only at a time at which there is no voltage loading in the respective zero-phase sequence systems of the at least two N-phase electric machines. The background of this is that in the prior art, the zero-phase sequence system also is used to produce a higher phase-to-phase voltage than would be possible with a fixed star point, in which a harmonic of a fundamental of the supply voltage is fed into the components of the zero-phase sequence system. In the case of an N-phase electric machine, this corresponds to the infeed of an N-th harmonic of a fundamental of the supply voltage. If a third harmonic is selected for this, a person skilled in the art refers to this as a third-harmonic injection. Since this takes place in the zero-phase sequence system, a potential difference of the N phases from one another remains unchanged, whereas a real value of the supply voltage and therefore the voltage potential in each winding assigned to a phase and at the neutral point of the star point increases. This would lead to uncontrollable current flows within field windings of those electric machines that are connected to one another at this moment. For this reason, it is advantageous, while the infeed is occurring, to perform a circuitry disconnection of the connection to an affected machine, or to re-establish the connection afterwards.

In a further embodiment of the method, the switch is selected as a semiconductor switch, in particular a bidirectional semiconductor switch, or as a mechanical switch. It is advantageously a switch that can be controlled by way of a control unit. In this case, it can also be a disconnector, which, although it is designed not to interrupt an existing current, does not permit a newly flowing current upon activation. Such a disconnector can be used to make it possible to balance different states of charge of the energy stores and to then open. This also corresponds to a use of semiconductor switches, for example thyristors, which do not permit a switch-off process until a flowing current stops or the direction of flow changes.

In a further embodiment of the method, a flow of energy is controlled by monitoring a potential difference between the N-phase electric machines. The potential difference, for example, is able to be determined by way of a respective voltage measurement with respect to a common ground potential and is able to be regulated by way of the respective inverter. A magnitude of the flow of energy determines the current flowing through the respective switch.

In another further embodiment of the method, the flow of energy is limited to a prescribed value. The flow of energy takes place by way of a current flowing through the windings of the respective field winding. Although the current does not contribute to the torque in the electric machine, it leads to losses in the windings that generally consist of copper. The losses manifest themselves as heating of the windings. To prevent these heating losses, the flow of energy is limited to a minimum load of the respective electric machine.

In one embodiment of the method, the switch to be closed to establish an electrical connection to at least one second field winding of a second N-phase electric machine is opened because the voltage loading in the zero-phase sequence system of a first N-phase electric machine is caused by way of an infeed of an N-th harmonic of a fundamental of a supply voltage. The infeed can be effected for example by way of a pulse-width-modulation method executed in an inverter.

In a further embodiment of the method, the switch to be closed to establish an electrical connection to at least one second field winding of a second N-phase electric machine is opened because the voltage loading in the zero-phase sequence system of a first N-phase electric machine is caused by way of a generative retroactive effect, referred to by the person skilled in the art as back-EMF, short for back electromotive force, of the first N-phase electric machine.

In another further embodiment of the method, the switch to be closed to establish an electrical connection to at least one second field winding of a second N-phase electric machine is opened because the voltage loading in the zero-phase sequence system of a first N-phase electric machine is caused by way of a surge current produced in the energy store assigned to the first N-phase electric machine by way of switching processes. The switching processes can be caused for example by way of the aforementioned inverter or by way of direct interconnection of individual battery modules.

In another further embodiment of the method, at least N battery modules are selected as respective energy stores. Each battery module comprises at least two circuit breakers and at least one energy cell connected to the circuit breakers, are selected as respective energy stores. The respective battery modules can be interconnected actively via the circuit breakers by means of a control unit such that they execute for example a pulse-width-modulation method for operating the assigned N-phase electric machine. An inverter that is required in the case of a passive battery is omitted in this case.

A system of the invention comprises at least two energy stores, at least two N-phase electric machines that are each operated by an energy store of the at least two energy stores and assigned to the respective energy stores, and at least one control unit that is equipped with a computer processor and a computer program running on the computer processor. The control unit is designed to control a respective energy store to operate the N-phase electric machine assigned to said energy store. The system also has at least one switch and is designed to execute a method as described above.

In one configuration of the system, a respective energy store comprises an energy module and an inverter. The inverter is configured to generate from a direct current provided by the energy module N phases of an alternating current necessary for operating an N-phase electric machine.

In a further configuration of the system, a respective energy store comprises at least N battery modules. Each battery module comprises at least two circuit breakers and at least one energy cell electrically connected to the at least two circuit breakers. These may be for example battery modules according to the principle of multi-level converter technology, as has been disclosed for example in DE 10 2010 052 934 A1.

Further advantages and configurations of the invention result from the description and the accompanying drawing.

It goes without saying that the features cited above and those yet to be explained below are usable not only in the respectively indicated combination but also in other combinations or on their own without departing from the scope of the present invention.

The figures are described consistently and generally; identical components have the same associated reference signs.

### BRIEF DESCRIPTION OF THE DRAWINGS

FIG. 1 is a schematic illustration according to the prior art of two drive systems that are associated with a respective axle of a motor vehicle and that do not have an electrical connection.

FIG. 2 is a schematic illustration of an embodiment of an interconnection, provided in accordance with the invention, of two drive systems associated with a respective axle of a motor vehicle.

FIG. 3 is a schematic illustration of an embodiment of an interconnection, provided in accordance with the invention, with a switch between the respective electric motors and fixedly wired negative poles of the respective energy stores.

FIG. 4 is a schematic illustration of an embodiment of an interconnection, provided in accordance with the invention, with a fixedly wired connection between the electric motors and a switch between the negative poles of the respective energy stores.

FIG. 5 is a schematic illustration of an embodiment of an interconnection, provided in accordance with the invention, with fixedly wired positive poles of the respective energy stores and a switch between the respective electric motors.

FIG. 6 is a schematic illustration of an embodiment of an interconnection, provided in accordance with the invention, with a fixedly wired connection between the electric motors and a switch between the positive poles of the respective energy stores.

FIG. 7 is a schematic illustration of two embodiments of an interconnection, provided in accordance with the invention, with a switch between different windings of the same phase of the respective field windings of the electric motors and fixedly wired negative poles of the respective energy stores.

FIG. 8 is a schematic illustration of a multi-level converter, which has been connected into two separate energy stores for a respective drive system.

FIG. 9 is a schematic illustration of an embodiment of an interconnection, provided in accordance with the invention, of a multi-level converter, divided into two energy stores, for two drive systems associated with a respective axle of the motor vehicle and having a switch between a connection of the neutral points of the respective electric motors.

FIG. 10 is a schematic illustration of an embodiment of an interconnection, provided in accordance with the invention, of a multi-level converter, divided into two energy stores, for two drive systems associated with a respective axle of the motor vehicle and having a switch between different windings of the same phase of the respective field windings of the electric motors.

### DETAILED DESCRIPTION

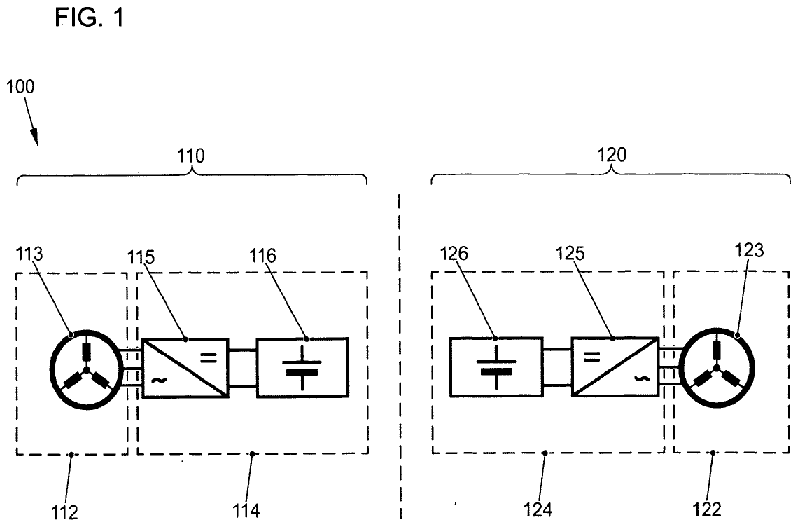

FIG. 1 shows a schematic illustration 100 according to the prior art of two drive systems 110, 120, which are associated with a respective axle of a motor vehicle and which do not have an electrical connection. A respective drive system consists of an energy store 114, 124 and an N-phase electric machine 112, 122. The respective energy store 114, 124 consists of an energy module 116, 126 and an inverter 115, 125, which from the DC voltage of the energy modules 116, 126 forms an N-phase AC voltage for a field winding 113, 123 of the N-phase electric machine 112, 122.

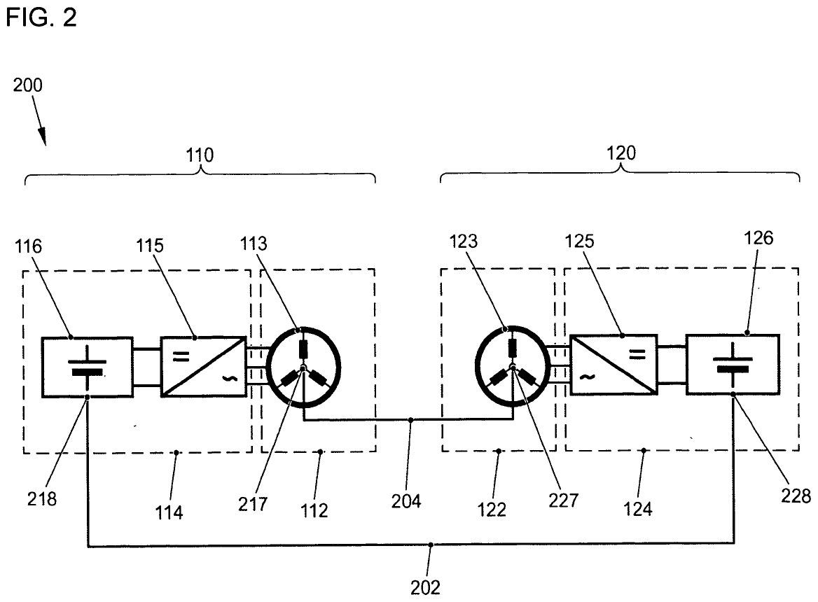

FIG. 2 shows a schematic illustration 200 of an embodiment of an interconnection, provided in accordance with the invention, of two drive systems 110, 120 associated with a respective axle of a motor vehicle. A negative pole 218 of the energy module 116 is connected to the negative pole 228 of the energy module 126 by way of a fixedly wired connection 202. A neutral point 217 of the field winding 113 is likewise connected to a neutral point 227 of the field winding 123 by way of a fixedly wired connection 204. If the energy modules 116 and 126 have different states of charge, an energy transfer takes place between the respective energy stores 114 and 124 by means of the respective zero-phase sequence system of the N-phase electric machines 112 and 122 that are otherwise in running operation.

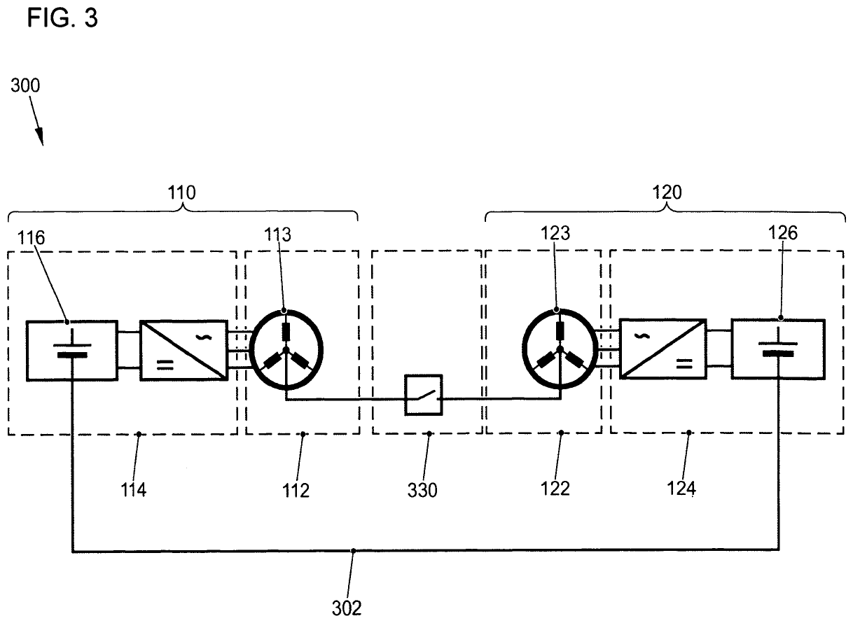

FIG. 3 shows a schematic illustration 300 of an embodiment of an interconnection, provided in accordance with the invention, of two drive systems 110, 120 associated with a respective axle of a motor vehicle. While respective negative poles of the batteries 116 and 126 are wired to one another by way of a fixed connection 302, a switch 330 is located between neutral points of the respective field windings 113 and 123. If there is voltage loading in one of the N-phase electric machines 112 and 122, for example owing to a third harmonic of the fundamental of a supply voltage of the corresponding field winding 113 or 123 being fed in, the switch 330 must be opened in order to prevent uncontrollable flows of current. Otherwise, when the switch 330 is closed, an energy transfer can take place between the respective energy stores 114 and 124 by means of the respective zero-phase sequence systems of the N-phase electric machines 112 and 122 that are otherwise in running operation.

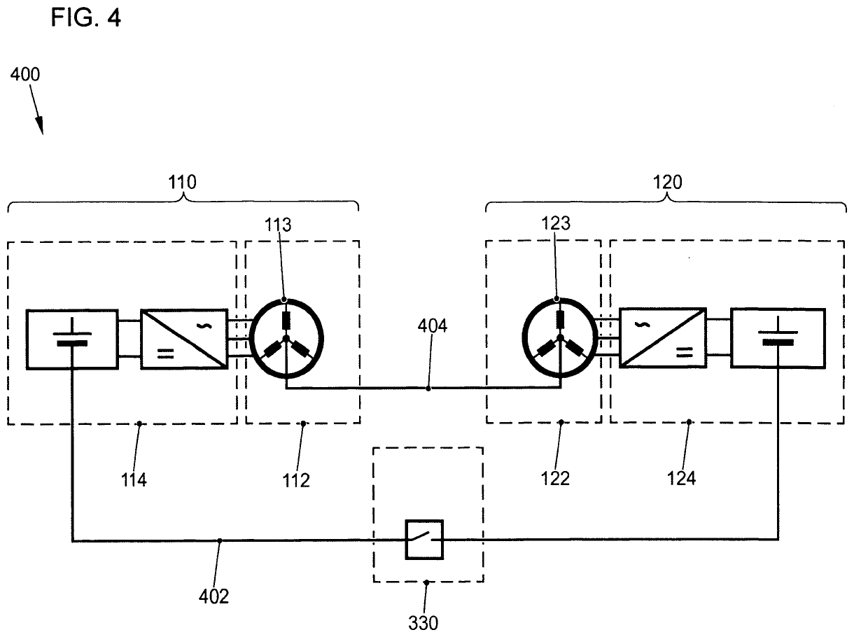

FIG. 4 shows a schematic illustration 400 of an embodiment of an interconnection, provided in accordance with the invention, of two drive systems 110 and 120 associated with a respective axle of a motor vehicle. In comparison with FIG. 3, there is a fixedly wired connection 404 between the neutral points of the respective field windings 113 and 123. The switch 330, which interrupts an energy transmission between the two energy stores 114, 124, is arranged between a connecting line 402 of the two negative poles of the energy stores 114, 124. In general, a switch 330 can be introduced at any location of a circuit including the connection between the respective field windings 113, 123, wherein, however, said switch must be arranged so that upon opening it does not stop the functioning of a system, assigned to said switch, composed of the respective energy store 114, 124 and the respective electric machine 112, 122 assigned to said energy store.

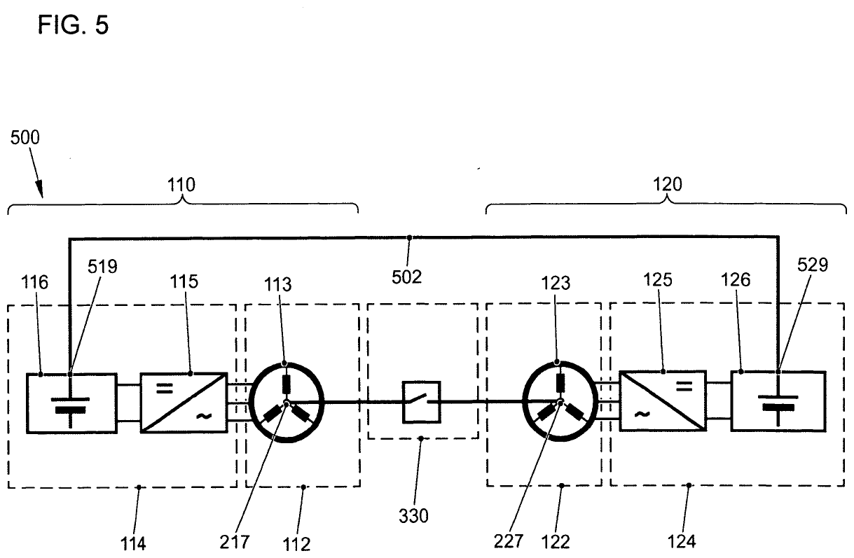

FIG. 5 shows a schematic illustration 500 of an embodiment of an interconnection, provided in accordance with the invention, of two drive systems 110 and 120 associated with a respective axle of the motor vehicle, wherein a positive pole 519 of the energy module 116 is connected to a positive pole 529 of the energy module 126 by way of a fixedly wired connection 502. A switch 330 is located between the neutral points of the respective field windings 113 and 123.

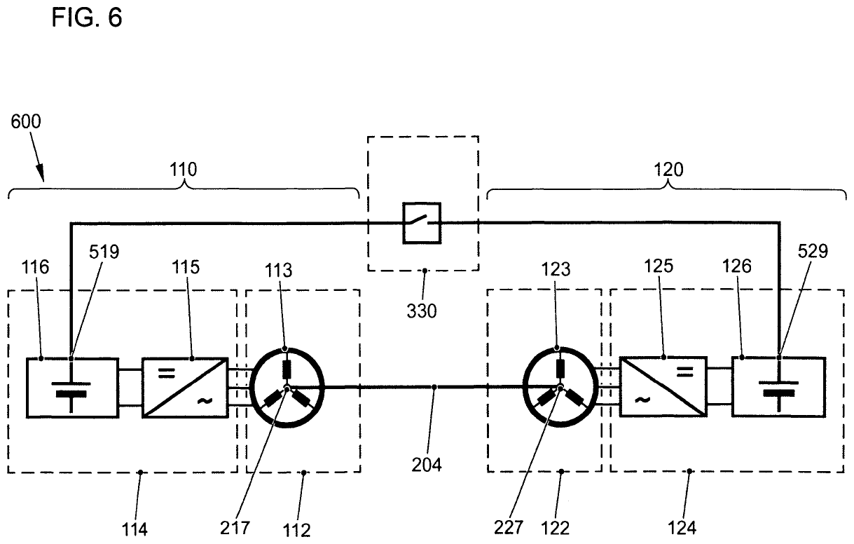

FIG. 6 shows a schematic illustration 600 of an embodiment of an interconnection, provided in accordance with the invention, of two drive systems 110 and 120 associated with a respective axle of a motor vehicle and having a fixedly wired connection 204 between the neutral points of the respective field windings 113 and 123. The switch 330, which interrupts an energy transmission between the two energy stores 114, 124, is arranged in a connecting line of the two positive poles 519 and 529 of the energy modules 116 and 126.

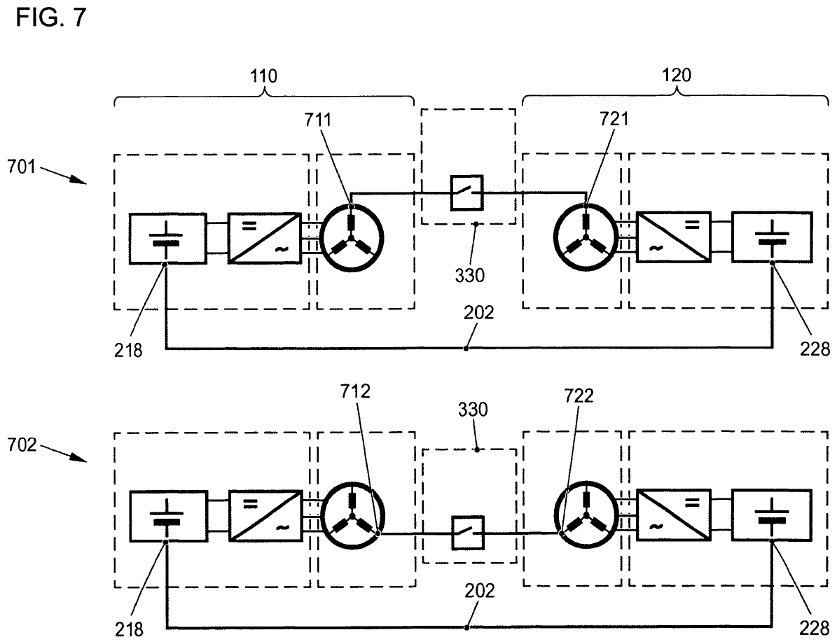

FIG. 7 shows a schematic illustration of two embodiments of an interconnection 701 and 702, provided in accordance with the invention, of two drive systems 110 and 120 associated with a respective axle of a motor vehicle, wherein a respective switch 330 is arranged between different windings 711, 721 and 712, 722 of the same phase of the respective field windings of the electric motors and the negative poles 218 and 228 of the respective energy stores are fixedly wired to one another via a connection 202. In the interconnection 701, the switch 330 is arranged in the connection to a connection point to the winding 711 of the field winding in the drive system 110 and a connection point to the winding 721 of the field winding in the drive system 120. In the interconnection 702, the switch 330 is arranged in the connection to a connection point to the winding 712 of the field winding in the drive system 110 and a connection point to the winding 722 of the field winding in the drive system 120. In general, N such connection point options are conceivable in the case of an N-phase electric motor.

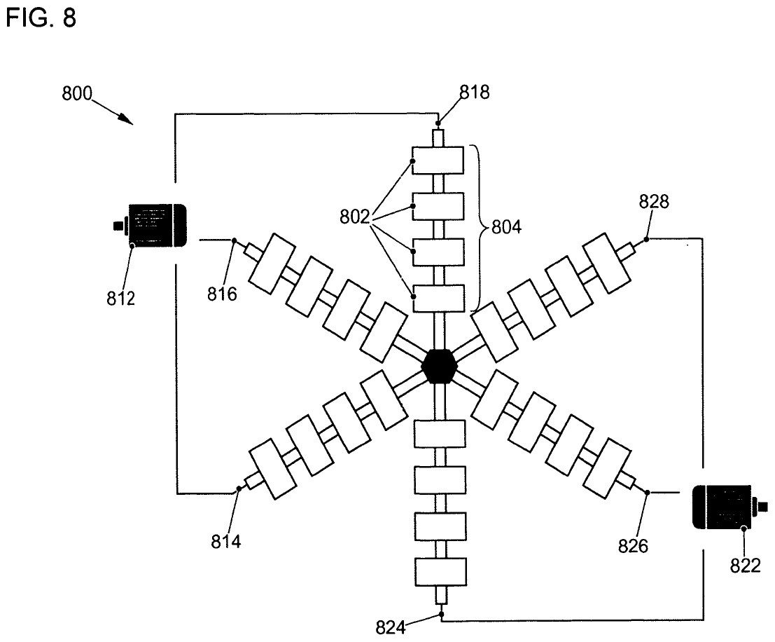

FIG. 8 shows a schematic illustration 800 of a multi-level converter, which has been connected into two separate energy stores for accordingly two drive systems and represents a special case for a system consisting of separate energy stores. The multi-level converter comprises a plurality of battery modules 802, wherein the battery modules 802 each have at least two circuit breakers and at least one energy cell electrically connected to the at least two circuit breakers. If there are a plurality of energy cells present per battery module 802, they are fixedly wired among one another in a predetermined series-parallel configuration. The battery modules 802 are arranged in N strings 804 per drive system, which form the respective phases. In the example shown here having a three-phase motor 812 and a three-phase motor 822, there are N=3 phases, which are present at the string end points 814, 816 and 818 for the three-phase motor 812 and are present at the string end points 824, 826 and 828 for the three-phase motor 822. The circuit breakers of the battery modules 802 permit a change in configuration of the battery modules 802 among one another during running operation. The shown configuration of the multi-level converter is affected exactly like the illustration 100 shown in FIG. 1 of different discharging by way of differently arising loadings of the respective drive systems.

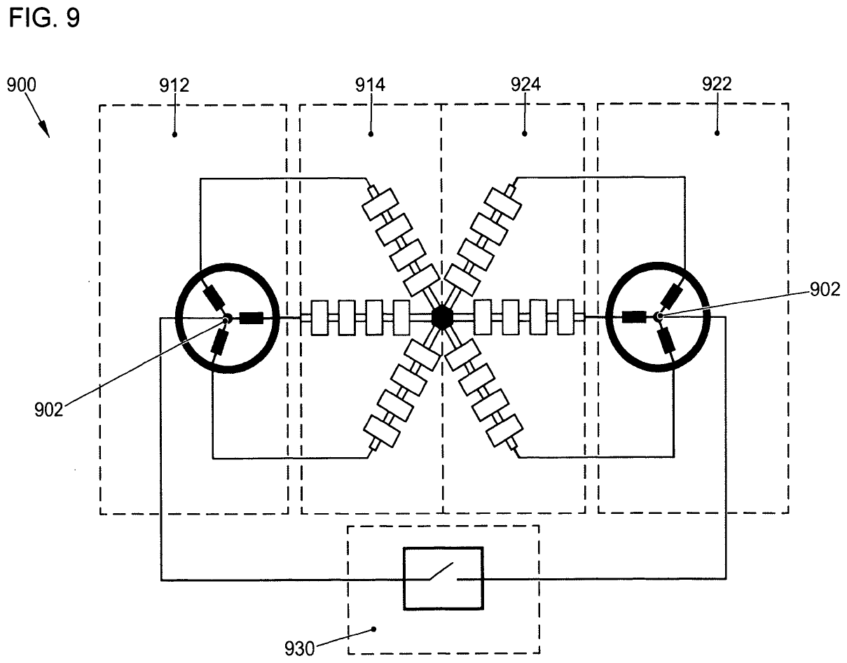

FIG. 9 shows a schematic illustration 900 of an embodiment of an interconnection, provided in accordance with the invention, of a multi-level converter, divided into two energy stores 914, 924, for accordingly two respective drive systems 912 and 922 associated with a respective axle of a motor vehicle. A switch 930 is advantageously introduced into a connecting line of the two neutral points 902 of the three-phase motors of the respective drive systems 912, 922. The method according to the invention makes provision for the switch 930 to be opened as soon as for example a third harmonic of the fundamental of the supply voltage produced by the multi-level converter is fed in for at least one of the two three-phase motors 912, 922. In the closed state of the switch 930, an energy transfer takes place between the energy stores 914 and 924. If for example the energy store 914 has a higher state of charge and therefore a higher voltage potential than the energy store 924, when the switch 930 is closed a current flows from the energy store 914 through the field winding of the three-phase motor 912 to the neutral point 916 thereof, and from there via the closed switch 930 to the neutral point 902 of the three-phase motor in the drive system 922, and by means of the field winding thereof to the energy store 924. This occurs as long as a potential difference prevails between the two energy stores 914, 924.

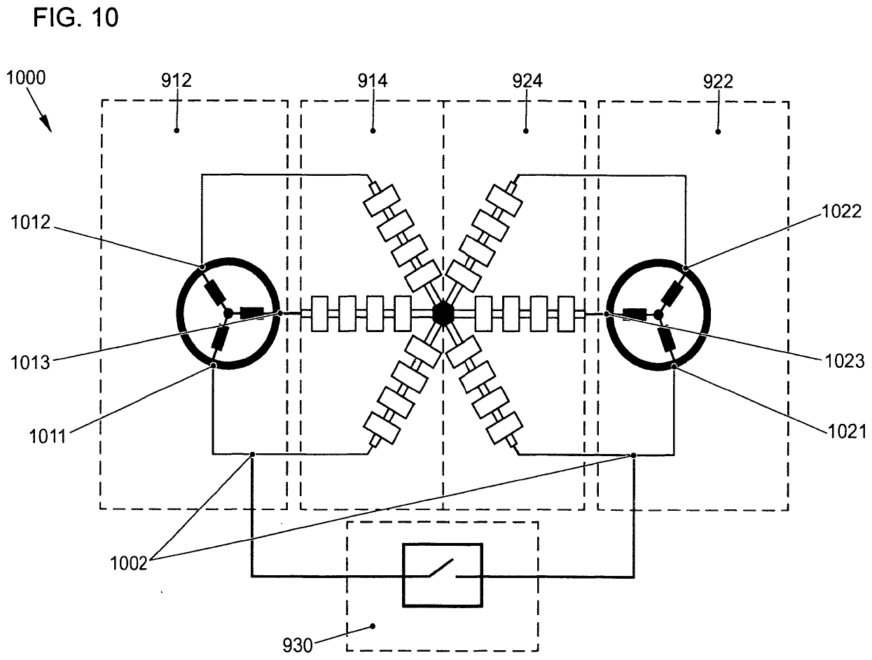

FIG. 10 shows a schematic illustration 1000 of an embodiment of an interconnection, provided in accordance with the invention, of a multi-level converter, divided into two energy stores 914 and 924, for two drive systems 912 and 922 associated with a respective axle of a motor vehicle, wherein a switch 930 is arranged between a connection point 1011 and a connection point 1021 to windings of the same phase of the respective field windings of the electric motors. In general, N such connection point options are conceivable in the case of an N-phase electric motor. In the embodiment shown in illustration 1000 having a three-phase motor, connections between the connection points 1012 and 1022, and between the connection points 113 and 123, respectively, to the respective windings of the respective field windings of the three-phase motors are alternatively conceivable.

1. A method for energy transmission between at least two energy stores (114, 124, 914, 924) in a respective zero-phase sequence system of at least two operational N-phase electric machines (112, 122, 912, 922) in a motor vehicle, in which the energy stores (114, 124, 914, 924) are assigned respectively to the N-phase electric machines (112, 122, 912, 922), by way of which for N=3 a three-phase motor is realized and which comprises a field winding (113, 123) joined at a star point, wherein the respective field winding has N windings corresponding to respective N phases and a neutral point (217, 227, 902), and an electrical connection is established in terms of circuitry between windings of corresponding phases or between the neutral points (217, 227, 902) of the respective field windings (113, 123) of the at least two N-phase electric machines (112, 122, 912, 922) and also between a respective identical pole of the energy stores (114, 124, 914, 924), as a result of which energy is transmitted between the at least two energy stores (114, 124, 914, 924) that have a different state of charge, by means of the field windings and the neutral points thereof of the at least two N-phase electric machines (112, 122, 912, 922).

2. The method of claim 1, in which a respective switch (330, 930) is arranged between windings of corresponding phases and/or between the neutral points of the respective field windings (113, 123) for establishing the electrical connection in terms of circuitry.

3. The method of claim 1, wherein the windings of corresponding phases and/or the neutral points of the respective field windings are electrically fixedly wired to one another and a respective switch (330) is arranged between a respective identical pole of the at least two energy stores for establishing the electrical connection in terms of circuitry.

4. The method of claim 3, in which the circuitry connection is established only at a time at which there is no voltage loading in the respective zero-phase sequence system of the at least two N-phase electric machines (112, 122, 912, 922).

5. The method of claim 3, in which the switch (330, 930) is a semiconductor switch or a mechanical switch.

6. The method of claim 1, wherein a flow of energy is controlled by monitoring a potential difference between the energy stores of the at least two N-phase electric machines (112, 122, 912, 922), said monitoring being effected by means of at least one inverter.

7. The method as claimed in claim 6, wherein the flow of energy is limited to a prescribed value.

8. The method of claim 3, in which the switch (330, 930) to be closed to establish an electrical connection to at least one second field winding of a second N-phase electric machine is opened because the voltage loading in the zero-phase sequence system of a first N-phase electric machine is caused by way of an infeed of an N-th harmonic of a fundamental of a supply voltage.

9. The method of claim 3, wherein the switch (330, 930) to be closed to establish an electrical connection to at least one second field winding of a second N-phase electric machine is opened because the voltage loading in the zero-phase sequence system of a first N-phase electric machine is caused by way of a generative retroactive effect of the first N-phase electric machine.

10. The method of claim 3, wherein the switch (330, 930) to be closed to establish an electrical connection to at least one second field winding of a second N-phase electric machine is opened because the voltage loading in the zero-phase sequence system of a first N-phase electric machine is caused by way of a surge current produced in the energy store by way of switching processes.

11. The method of claim 1, wherein at least N battery modules (802), which each comprise at least two circuit breakers and at least one energy cell connected to the circuit breakers, are selected as respective energy store.

12. A system of a motor vehicle, the system comprises at least two energy stores (114, 124, 914, 924), at least two N-phase electric machines, by way of which for N=3 a three-phase motor is realized and which are each operated by way of an energy store (114, 124, 914, 924) of the at least two energy stores (114, 124, 914, 924) and assigned to the respective energy stores (114, 124, 914, 924), at least one control unit equipped with a computer processor and a computer program running on the computer processor the control unit being designed to control a respective energy store to operate the N-phase electric machine assigned to said energy store, and at least one switch (330, 930), wherein the system is designed to execute the method of claim 1, wherein the system is configured to transmit energy between the at least two energy stores (114, 124, 914, 924) when they have a different state of charge, by means of the field windings and the neutral points thereof of the at least two N-phase electric machines (112, 122, 912, 922).

13. The system of claim 12, wherein the respective energy store (114, 124) comprises an energy module (116, 126) and an inverter, wherein the inverter is configured to generate from a direct current provided by the energy module N phases of an alternating current necessary for operating the N-phase electric machine (112, 124) assigned to the energy store (114, 124).

14. The system of claim 12, wherein the respective energy store (914, 924) comprises at least N battery modules (802), wherein each respective battery module (802) comprises at least two circuit breakers and at least one energy cell electrically connected to the at least two circuit breakers.
